(19) United States
(12) Patent Application Publication
(10) Pub. No.: US 2026/0177147 A1
(43) Pub. Date: Jun. 25, 2026

(54) HIGH PRESSURE SEAL ADAPTED FOR USE AS A CFT SEAL

(71) Applicant: CDI Energy Products, Inc., Humble, TX (US)

(72) Inventors: N.S. Rajkumar, Singapore (SG); Soman M Sadanandan, Singapore (SG)

(21) Appl. No.: 19/426,602

(22) Filed: Dec. 19, 2025

Related U.S. Application Data
(60) Provisional application No. 63/736,975, filed on Dec. 20, 2024.

(51) Int. Cl. F16J 15/3204

(52) U.S. Cl. CPC F16J 15/3204

(57) ABSTRACT

A seal with an optimized profile that provides enhanced sealing performance for high pressure operating conditions while ensuring compliance with applicable standards and performance requirements is disclosed. The seal comprises an annular body having a first side, an opposite second side, an inner surface, and an outer surface. The inner surface includes a radially inwardly extending projection. At least a portion of the projection has a substantially trapezoidal cross-sectional shape.

### CROSS-REFERENCE TO RELATED APPLICATION

This application claims the benefit of U.S. Provisional Patent Application Ser. No. 63/736,975, filed Dec. 20, 2024, the entirety of which is herein incorporated by reference.

### FIELD

The disclosure relates to a seal, and more particularly to a high pressure seal with an optimized profile that provides enhanced sealing performance while ensuring compliance with applicable standards and performance requirements.

### BACKGROUND

FS seals are specialized sealing components designed for use in demanding environments, particularly in industries where high pressures, extreme temperatures, and aggressive chemicals are present. Unlike traditional seals, FS-Seals are engineered to deliver superior performance, especially in the oil and gas sector, where resistance to fluids as per American Petroleum Institute (API) specification 6A Immersion against FF/HH and the explosive decompression (AED) is critical. These seals are commonly utilized in wellheads and other critical components, offering reliability under conditions that challenge conventional sealing technologies. Their design and material selection aim to ensure durability and operational integrity in environments characterized by rapid pressure fluctuations and harsh chemical exposure.

In wellhead applications, FS-Seals are frequently employed for casing and tubing hangers due to their ability to meet stringent operational requirements. These include exposure to rough casing surfaces exceeding 250 microns, accommodation of large diametrical clearances dictated by API specification 5CT casing tolerances, and maintenance of sealing integrity under extreme pressure ratings of up to 15,000 psi and temperature ranges from 0° F. to 300° F. Traditionally, FS-Seals feature a pronounced concavity on the back side (FIG. 1), a design intended to facilitate stab-in installation and compensate for the wide dimensional variations inherent in API 5CT casing specifications. Historically, these seals were qualified for pressure and temperature performance based on nominal casing dimensions and were successfully deployed in numerous wellhead systems.

However, evolving industry standards have introduced more rigorous qualification requirements, notably the API 6A PR2F standard. This specification mandates comprehensive testing that includes temperature cycling at both extremes of the operating range while maintaining rated pressure, as well as validation across the full spectrum of casing tolerances. API 5CT prescribes a tolerance of +1.0%/−0.5% regardless of size, which results in increasingly significant diametrical clearances (extrusion gaps) for larger casing sizes. Consequently, FS-seals must now demonstrate reliable performance under a challenging combination of conditions: temperature variations from 0° F. to 300° F., pressure ratings between 10,000 psi and 15,000 psi, and dimensional variability across the entire casing range.

These enhanced requirements have exposed critical limitations in the conventional FS-Seal design. Specifically, the concavity at the outer diameter (FIG. 1) contributes to vulnerability under PR2F testing, leading to failures such as Rapid Gas Decompression (RGD) and extrusion. The traditional FS-Seal configuration, while effective under earlier standards, has proven inadequate for maintaining sealing integrity across the expanded tolerance range and severe qualification conditions now demanded by the oil and gas industry.

Accordingly, there is a need for a seal with an optimized profile that provides enhanced sealing performance while ensuring compliance with applicable standards and performance requirements.

### SUMMARY

In concordance and agreement with the presently described subject matter, a seal with an optimized profile that provides enhanced physical properties while ensuring compliance with applicable standards and performance requirements, has surprisingly been discovered.

In one embodiment, a seal comprises: an annular body having a first side and an opposite second side, the body bounded by an inner surface and an outer surface, wherein the inner surface includes a radially inwardly extending projection, and wherein at least a portion of the projection has a substantially trapezoidal cross-sectional shape.

In another embodiment, a wellhead assembly comprises: a first component; a second component disposed adjacent to the first component; and a seal positioned between the first and second components to militate against fluid leakage therebetween, the seal including an annular body bounded by an inner surface and an outer surface, wherein the inner surface includes a radially inwardly extending projection, and wherein at least a portion of the projection has a substantially trapezoidal cross-sectional shape.

As aspects of some embodiments, the first side of the seal is substantially planar.

As aspects of some embodiments, the second side of the seal is substantially planar.

As aspects of some embodiments, the outer surface of the seal includes a concave arcuate recess between a first lobe and a second lobe of the body.

As aspects of some embodiments, the body of the seal includes a first circular aperture proximate a first lobe thereof.

As aspects of some embodiments, the body of the seal includes a second circular aperture proximate a second lobe thereof.

As aspects of some embodiments, the first and second circular apertures of the seal are laterally offset from a recess formed in the outer surface.

As aspects of some embodiments, the first and second circular apertures of the seal are concentrically aligned.

As aspects of some embodiments, each of the first and second circular apertures of the seal is configured to receive a biasing element therein.

As aspects of some embodiments, the projection of the seal provides a sealing surface configured to engage a complementary sealing surface to form a fluid-tight barrier when the body is compressed.

As aspects of some embodiments, the body of the seal is monolithic.

As aspects of some embodiments, the body of the seal is produced from at least one elastomeric material selected from nitrile rubber (NBR), hydrogenated nitrile butadiene rubber (HNBR), ethylene propylene diene monomer (EPDM) rubber, fluorocarbon-based fluoroelastomer (FKM), silicone, polyurethane, or thermoplastic elastomer.

As aspects of some embodiments, the outer surface of the seal is substantially planar.

As aspects of some embodiments, the substantially trapezoidal shaped portion of the projection of the seal includes an inner surface and opposing non-parallel sides, and wherein the inner surface of the projection is substantially parallel to the inner surface of the body.

As aspects of some embodiments, an inner surface of the substantially trapezoidal shaped portion of the body has an arcuate shape.

As aspects of some embodiments, the projection of the seal includes opposing planar sides.

As aspects of some embodiments, the inner surface of the body of the seal and at least one of the planar sides of the projection of the seal meet to form at least one seating interface.

As aspects of some embodiments, the seal further comprises at least one reinforcement member disposed on the at least one seating interface.

As aspects of some embodiments, the at least one reinforcement member of the seal is produced from a wire mesh material or a wire mesh including elastomeric material.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a fragmentary perspective view of a prior art FS seal;

FIG. 2 is a perspective view, partially in section, of a seal according to an embodiment of the present disclosure, wherein portions of the seal and associated springs are not shown;

FIG. 3 is a cross-sectional view of the seal of FIG. 2;

FIG. 4 is a perspective view partially in section of a seal according to another embodiment of the present disclosure;

FIG. 5 is a cross-sectional view of the seal of FIG. 4;

FIG. 6 is a sectional view of a portion of a wellhead assembly including the seal of FIGS. 4 and 5; and

FIG. 7 is a schematic representation of a pressure and temperature cycling test sequence related to API 6A PR2F standards.

### DETAILED DESCRIPTION

The following description of technology is merely exemplary in nature of the subject matter, manufacture and use of one or more present disclosures, and is not intended to limit the scope, application, or uses of any specific present disclosure claimed in this application or in such other applications as may be filed claiming priority to this application, or patents issuing therefrom. Regarding methods disclosed, the order of the steps presented is exemplary in nature, and thus, the order of the steps may be different in various embodiments. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

All documents, including patents, patent applications, and scientific literature cited in this detailed description are incorporated herein by reference, unless otherwise expressly indicated. Where any conflict or ambiguity may exist between a document incorporated by reference and this detailed description, the present detailed description controls.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, all compositional percentages are by weight of the total composition, unless otherwise specified. Disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” may encompass both an orientation of above and below. The device may be otherwise oriented (rotated 90 degrees or at other orientations) and the spatially relative descriptors used herein interpreted accordingly.

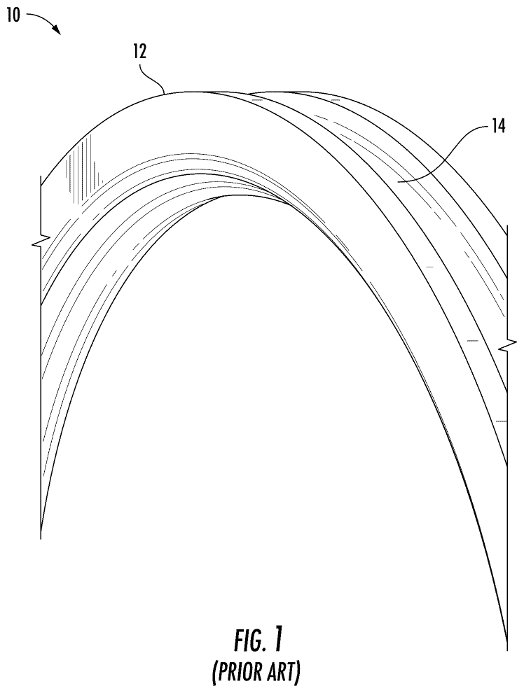

FIG. 1 illustrates a conventional FS seal 10. The conventional FS seal 10 including an annular body 12 having a concavity 14 at an outer diameter.

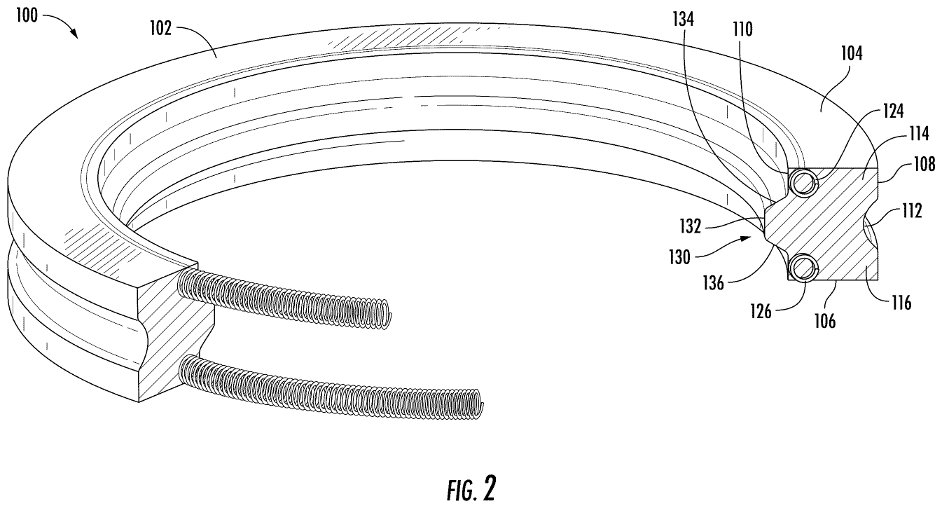

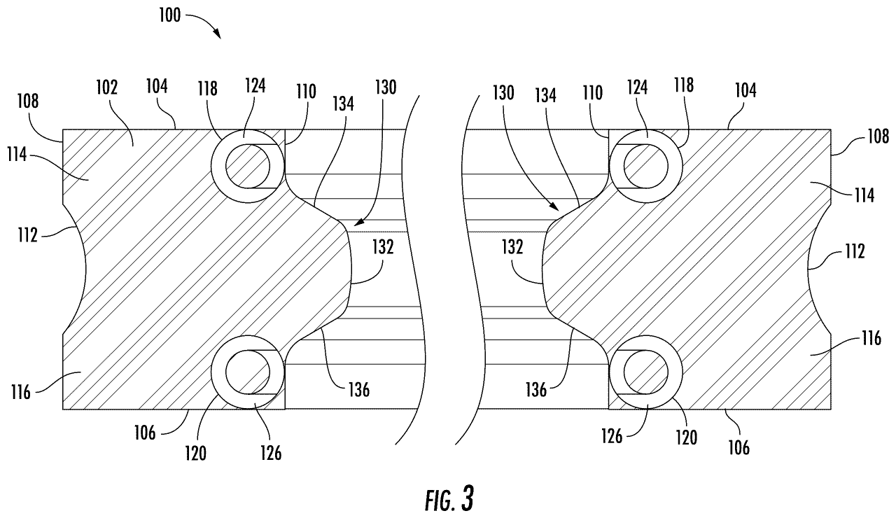

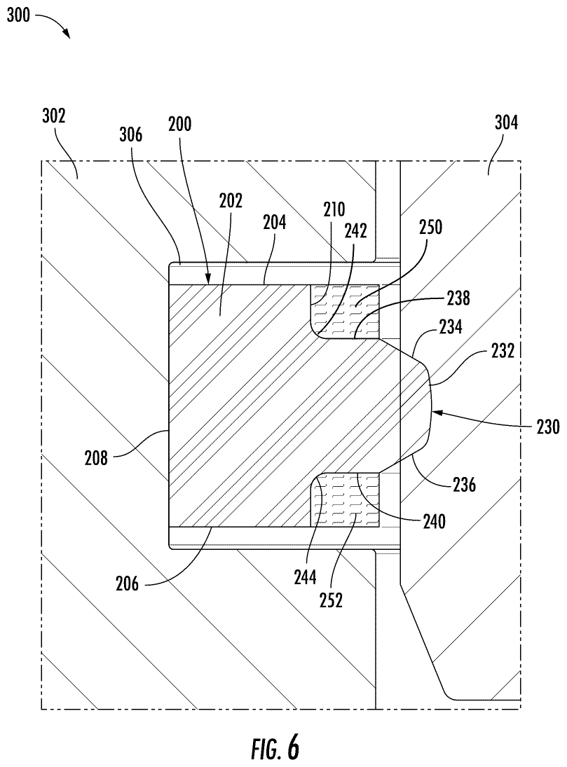

FIGS. 2 and 3 illustrate a seal 100 in accordance with an embodiment of the present disclosure. The seal 100 may be, but is not limited to, a CFT seal for a wellhead assembly 300 (shown in FIG. 6 and described hereinbelow).

The seal 100 comprises an annular body 102 having a generally rectangular cross-section. As depicted, the body 102 is formed as a monolithic structure. However, it should be understood that the body 102 may alternatively be constructed from multiple separate components, if desired. It should be further understood that the body 102 may be produced from any suitable material such as at least one elastomeric material selected from nitrile rubber (NBR), hydrogenated nitrile butadiene rubber (HNBR), ethylene propylene diene monomer (EPDM) rubber, fluorocarbon-based fluoroelastomer (FKM), silicone, polyurethane, or thermoplastic elastomer, for example.

As illustrated, the body 102 is bounded by an upper first side 104, a lower second side 106, an outer surface 108, and an inner surface 110. As shown, each of the first and second sides 104, 106 is generally planar having a generally smooth surface. In some embodiments, the outer surface 108 includes a concave arcuate recess 112 between a first lobe 114 and a second lobe 116 of the body 102. In the embodiment shown in FIGS. 2 and 3, a first circular aperture 118 may be formed proximate the first lobe 114 of the body 102, and a second circular aperture 120 may be formed proximate the second lobe 116 thereof. The first and second circular apertures 118, 120 depicted are laterally offset from the recess 112 formed in the outer surface 108. In certain embodiments, the first and second circular apertures 118, 120 are concentrically aligned. Each of the first and second circular apertures 118, 120 may be configured to receive an associated biasing element 124, 126 therein. The biasing elements 124, 126 serve to ensure high-pressure resilience and prevent extrusion of the seal 100. The biasing elements 124, 126 respond to pressure fluctuations during operation, moving to close any clearance gap between mating components. This is crucial in applications where the seal 100 must withstand significant pressure changes, such as in a wellhead assembly. Various types of biasing elements 124, 126 may be utilized, including, for example, helical or coil springs.

In preferred embodiments, the inner surface 110 includes a radially inwardly extending projection 130. At least a portion of the projection 130 has a substantially trapezoidal cross-sectional shape. As depicted in FIGS. 2 and 3, the substantially trapezoidal shaped portion of the projection 130 includes an inner surface 132 and opposing non-parallel sides 134, 136. In some embodiments, the sides 134, 136 may be oriented at an angle relative to the inner surface 132, ranging from approximately 25°-75°, preferably between 30°-60°, and more preferably at approximately 45°. The inner surface 132 of the projection 130 may be substantially parallel to the inner surface 110 of the body 102. In some embodiments, however, the inner surface 132 of the projection 130 may have a slight arcuate shape.

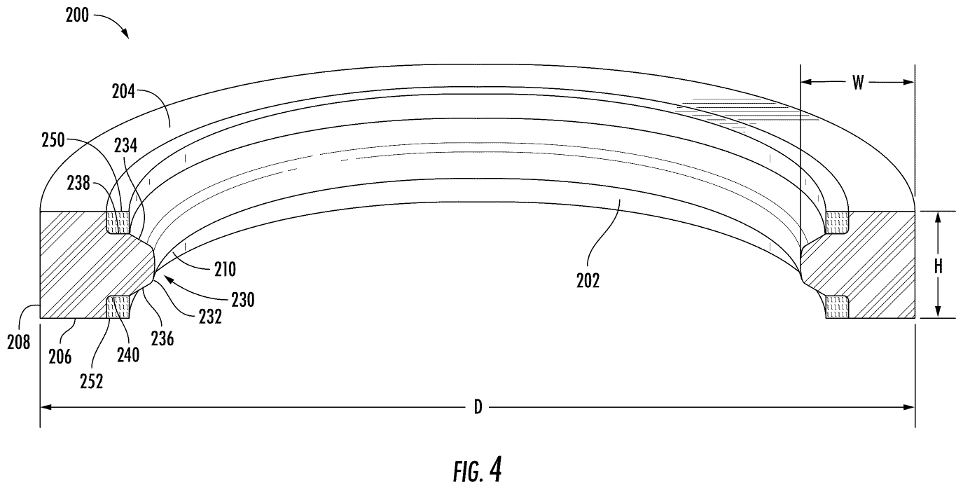

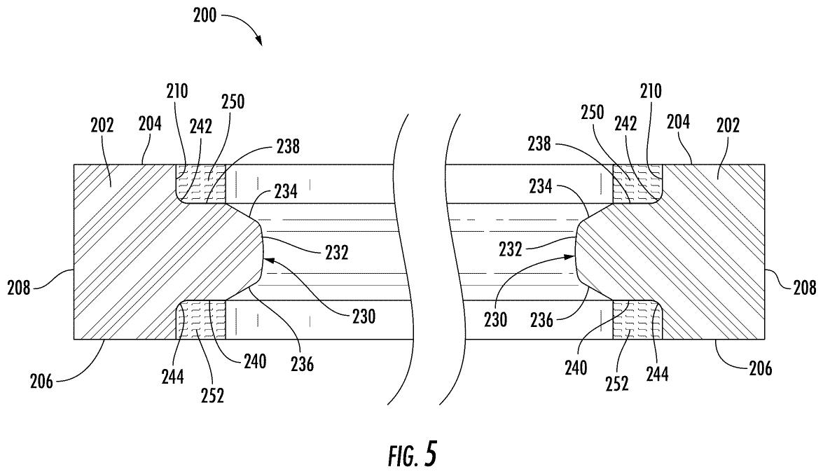

FIGS. 4-5 illustrate a seal 200 according to another embodiment of the present disclosure. The seal 200 is generally similar to the seal 100 shown in FIGS. 2 and 3 and may be, but is not limited to, a CFT seal for the wellhead assembly 300. For clarity, reference numerals identifying corresponding structure are repeated herein using a two-hundred series designation. A detailed description of similar structure is not repeated herein for simplicity. In this embodiment, the concave arcuate recess of the seal 100 is omitted. Additionally, the projection 230 of the seal 200 includes the substantially trapezoidal shaped portion along with opposing planar sides 238, 240. The sides 238, 240 together with the inner surface 210 of the body 202 meet to form seating interfaces 242, 244, respectively. Each of the seating interfaces 242, 244 is configured to receive a respective one of reinforcement members 250, 252 to enhance structural integrity and load-bearing capability. The reinforcement members 250, 252 may be produced from a wire mesh material or, in certain embodiments, a wire mesh impregnated or infused with an elastomeric material such as rubber. This configuration provides improved resistance to extrusion and deformation under high-pressure conditions while maintaining flexibility for installation of the seal 200. Specifically, the seal 200, particularly the CFT seal 200, is rated for pressures up to 15,000 pounds per square inch (psi) and temperatures ranging from 0° F. to 300° F.

In certain embodiments, the seal 200 may have a height (H) of approximately 0.695-0.715 inches, an outer diameter (D) of approximately 6.225-6.275 inches, and a width (W) of approximately 0.745-0.775 inches. It is understood, however, that alternative dimensions and configurations of the seal 200 may be employed as desired. It is also understood that the seal 200 may be at least partially manufactured using skive cutting for smaller-sized seals 200 to facilitate the installation of the reinforcement members 250, 252 on the seating interfaces 242, 244.

FIG. 6 illustrates a wellhead assembly 300 including the seal 200 according to an embodiment of the present disclosure. It is understood that seal 100 may be utilized instead of seal 200 if desired. For simplicity, the wellhead assembly 300 with only the seal 200 is described herein. The wellhead assembly 300 includes a first mating component 302 (e.g., a wellhead casing hanger) and a second mating component 304 (e.g., a wellhead casing). It is understood that the seal 200 may be utilized between various mating components of the wellhead assembly 300 as desired. As shown, the first mating component 302 may include a captive groove 306 to retain the seal 200 therein. The captive groove 302 may include undercuts or retention features for retaining the seal 200 therein.

The seal 200 is installed between the first and second mating components 302, 304, either manually or assisted with an internal seal twister and pushed gently into the captive groove 306. The radial squeeze against the second mating component 304 compresses the seal 200 causing the substantially trapezoidal shaped portion of the projection 230 to deform slightly. Such deformation enables the projection 230 to span an extrusion gap and sealing surfaces of the projection 230 to be urged against opposing sealing surfaces, establishing a continuous fluid-tight barrier. The extrusion gap refers to an interstice between the first and second mating components 302, 304. The compression generates radial expansion within the body 202 of the seal 200, which enhances contact pressure along the sealing surfaces and prevents fluid migration.

Advantageously, the substantially trapezoidal shaped portion of the projections 130, 230 provides a geometric configuration that increases the effective contact area between the sealing surfaces of the projections 130, 230 and one or more of the mating components. By enlarging the sealing surfaces, the substantially trapezoidal shaped portion of the projections 130, 230 distributes applied loads more uniformly across the effective contact area, thereby reducing localized stress concentrations that could otherwise lead to deformation or fluid leakage. This enhanced load distribution contributes to improved structural rigidity of the projections 130, 230 under compressive and shear forces encountered during high-pressure operation. In addition, the substantially trapezoidal shaped portion of the projections 130, 230 increases a cross-sectional moment of inertia of the projection 130 relative to conventional sinusoidal profiles. Such increase in structural stiffness translates into a higher effective shear modulus for the projections 130, 230, which resists lateral displacement and extrusion under differential pressure conditions. The resulting improvement in mechanical stability enables the seals 100, 200 to maintain sealing integrity at elevated pressure ratings, surpassing the performance of conventional seals that rely on less robust projection geometries. Further, the substantially trapezoidal shaped portion of the projections 130, 230 may facilitate controlled deformation of the seals 100, 200, respectively, during installation, allowing the projections 130, 230 to engage mating surfaces in a manner that enhances sealing reliability without excessive compression set. In certain embodiments, the non-parallel sides 134, 136, 234, 236 of the respective projections 130, 230 may act as self-centering features, promoting accurate alignment with complementary grooves or recesses in one or more of the mating components. This alignment capability further reduces assembly errors and ensures consistent sealing performance across a range of operating conditions.

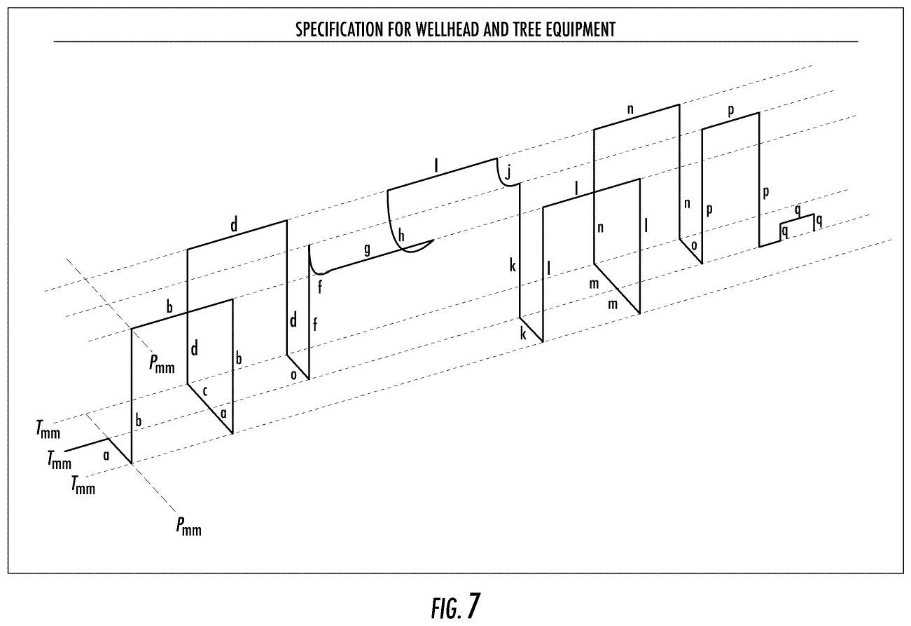

FIG. 7 is a schematic representation of a pressure and temperature cycling test sequence related to API 6A PR2F standards. This rigorous test sequence is designed to validate the performance and reliability of wellhead and Christmas tree equipment under extreme operating conditions. In particular, the test sequence ensures that the equipment can maintain structural integrity and sealing capability when subjected to repeated cycles of pressure and temperature variations, simulating real-world service environments such as high-pressure/high-temperature (HP/HT) wells. Compliance with API 6A PR2F provides confidence in equipment reliability for critical applications.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods may be made within the scope of the present technology, with substantially similar results.

What is claimed is:

1. A seal, comprising:
an annular body having a first side and an opposite second side, the body bounded by an inner surface and an outer surface, wherein the inner surface includes a radially inwardly extending projection, and wherein at least a portion of the projection has a substantially trapezoidal cross-sectional shape.

2. The seal of claim 1, wherein the first side is substantially planar.

3. The seal of claim 1, wherein the second side is substantially planar.

4. The seal of claim 1, wherein the outer surface includes a concave arcuate recess between a first lobe and a second lobe of the body.

5. The seal of claim 1, wherein the body includes a first circular aperture proximate a first lobe thereof.

6. The seal of claim 5, wherein the body includes a second circular aperture proximate a second lobe thereof.

7. The seal of claim 6, wherein the first and second circular apertures are laterally offset from a recess formed in the outer surface.

8. The seal of claim 6, wherein the first and second circular apertures are concentrically aligned.

9. The seal of claim 6, wherein each of the first and second circular apertures is configured to receive a biasing element therein.

10. The seal of claim 1, wherein the projection provides a sealing surface configured to engage a complementary sealing surface to form a fluid-tight barrier when the body is compressed.

11. The seal of claim 1, wherein the body is monolithic.

12. The seal of claim 1, wherein the body is produced from at least one elastomeric material selected from nitrile rubber (NBR), hydrogenated nitrile butadiene rubber (HNBR), ethylene propylene diene monomer (EPDM) rubber, fluorocarbon-based fluoroelastomer (FKM), silicone, polyurethane, or thermoplastic elastomer.

13. The seal of claim 1, wherein the outer surface is substantially planar.

14. The seal of claim 1, wherein the substantially trapezoidal shaped portion of the projection includes an inner surface and opposing non-parallel sides, and wherein the inner surface of the projection is substantially parallel to the inner surface of the body.

15. The seal of claim 1, wherein an inner surface of the substantially trapezoidal shaped portion of the body has an arcuate shape.

16. The seal of claim 1, wherein the projection includes opposing planar sides.

17. The seal of claim 16, wherein the inner surface of the body and at least one of the planar sides of the projection meet to form at least one seating interface.

18. The seal of claim 17, further comprising at least one reinforcement member disposed on the at least one seating interface.

19. The seal of claim 18, wherein the at least one reinforcement member is produced from a wire mesh material or a wire mesh including elastomeric material.

20. A wellhead assembly, comprising:
a first component;
a second component disposed adjacent to the first component; and
a seal positioned between the first and second components to militate against fluid leakage therebetween, the seal including an annular body bounded by an inner surface and an outer surface, wherein the inner surface includes a radially inwardly extending projection, and wherein at least a portion of the projection has a substantially trapezoidal cross-sectional shape.
